(19) United States
(12) Patent Application Publication
(10) Pub. No.: US 2025/0381894 A1
(43) Pub. Date: Dec. 18, 2025

(54) ADJUSTMENT DEVICE FOR A VEHICLE SEAT WITH A SWIVEL ELEMENT HAVING A DEFORMATION SECTION

(71) Applicant: BROSE FAHRZEUGTEILE SE & CO. KOMMANDITGESELLSCHAFT, COBURG, Coburg (DE)

(72) Inventors: Florian LIPP, Unterlauter (DE); Julian BARTSCH, Ebensfeld (DE); Frank STEINER, Truckenthal (DE); Mirko FEIST, Aachen (DE)

(21) Appl. No.: 18/879,159

(22) PCT Filed: Jun. 23, 2023
(86) PCT No.: PCT/EP2023/067102

§ 371 Date: Dec. 26, 2024

(30) Foreign Application Priority Data
Jun. 27, 2022 (DE) 10 2022 206 460.7

(51) Int. Cl. B60N 2/427; B60N 2/42

(52) U.S. Cl. CPC B60N 2/42781; B60N 2/4228

(57) ABSTRACT

An adjustment device for a vehicle seat comprises a first assembly and a second assembly adjustable relative to the first assembly. A swivel element includes a toothed segment and a flat element connected to the toothed segment and is pivotable for adjusting the first assembly and the second assembly relative to each other. An adjustment drive includes a pinion element cooperating with the toothed segment, which can be driven pivot the swivel element. The toothed segment includes a support section, wherein the toothed segment is connected to the flat element on a first side of the deformation section, and the support section configured to support on the flat element on a second side of the deformation section and/or on one of the first assembly and the second assembly in the case of a deformation of the deformation section.

### CROSS REFERENCE TO RELATED APPLICATIONS

The present application is a U.S. National Phase of International Application No. PCT/EP2023/067102 entitled “ADJUSTMENT DEVICE FOR A VEHICLE SEAT WITH A SWIVEL ELEMENT HAVING A DEFORMATION SECTION,” and filed on Jun. 23, 2023. International Application No. PCT/EP2023/067102 claims priority to German Patent Application No. 10 2022 206 460.7 filed on Jun. 27, 2022. The entire contents of each of the above-listed applications are hereby incorporated by reference for all purposes.

### BACKGROUND

This solution relates to an adjustment device for a vehicle seat.

Such an adjustment device includes a first assembly, a second assembly adjustable relative to the first assembly, a swivel element and an adjustment drive. The swivel element comprises a toothed segment and a flat element connected to the toothed segment and is pivotable for adjusting the first assembly and the second assembly relative to each other. The adjustment drive includes a pinion element cooperating with the toothed segment, which can be driven to pivot the swivel element. The flat element of the swivel element includes a first coupling section coupled with the first assembly, a second coupling section coupled with the second assembly, and a deformation section arranged between the first coupling section and the second coupling section.

Such a swivel element serves for adjustably coupling two assemblies of a vehicle seat with each other. For example, in a height adjustment device a seat part of the vehicle seat can be coupled with a floor assembly, for example a longitudinal adjustment device for longitudinally adjusting the vehicle seat, via a plurality of swivel elements, for example two pairs of two swivel elements each. The swivel elements of the height adjustment device can be pivoted in order to thereby vary a height position of the seat part relative to the floor assembly. A swivel element here is operatively connected to an adjustment drive and thus can be pivoted via the adjustment drive.

In a vehicle seat care must be taken in general that loading forces can be absorbed and dissipated reliably also at great loads, in particular in the event of a crash. In a height adjustment device, forces here in particular are to be supported on a swivel element operatively connected to an adjustment drive, in order to avoid an uncontrolled movement or even breaking away of the vehicle seat in the event of a crash, which otherwise might involve a considerable risk of injury for a vehicle occupant.

Here, however, there is an endeavor to configure components of the vehicle seat as lightweight and inexpensive as possible, in order to provide for a simple, lightweight and inexpensive manufacture of the vehicle seat.

Moreover, in a swivel element for example of a height adjustment device it possibly is desirable that under the load of a crash the swivel element can be deformed so as to provide for a certain movement of the vehicle seat in the sense of a crumple zone in order to thereby absorb crash forces and for example counteract a whiplash injury of a vehicle occupant. On such a swivel element a deformation section can be provided therefor, on which the swivel element can be deformed properly under the load of a crash.

A swivel support for a vehicle seat known from DE 199 53 758 C1 includes two layers which in an unloaded state closely rest against each other but are separated from each other. The layers have different buckling resistances, wherein the layer with the greater buckling resistance is longitudinally shiftable by a specified path on at least one abutment point and the layer with the smaller buckling resistance is configured for laterally buckling under overload.

It is an object underlying the proposed solution to provide an adjustment device for a vehicle seat, in which a swivel element can be designed of light weight, with a crash-proof connection of associated assemblies to each other.

This object is achieved by an adjustment device as described herein. Accordingly, the toothed segment includes a support section. On a first side of the deformation section, the toothed segment is connected to the flat element. In the case of a deformation of the deformation section as a result of loading forces acting on the swivel element in the event of a crash the support section is configured to support on the flat element on a second side of the deformation section and/or on one of the first assembly and the second assembly.

The swivel element is part of an adjustment device via which associated assemblies can be adjusted relative to each other. The swivel element here is pivotable relative to at least one of the assemblies and is operatively connected to an adjustment drive which is in meshing engagement with a toothed segment of the swivel element via a pinion element. By driving, the pinion element can be rotated relative to the toothed segment and thereby meshes with a toothing of the toothed segment so that the swivel element is pivoted and the assemblies thus are adjusted relative to each other.

The swivel element includes a flat element which is connected to the toothed segment. The flat element forms a first coupling section which is coupled with the first assembly and a second coupling section which is coupled with the second assembly, and in this way realizes a lever between the assemblies, which driven by the adjustment drive can be pivoted so as to adjust the assemblies relative to each other.

On the flat element a deformation section is formed, which is located between the first coupling section and the second coupling section and provides for a deformation on the flat element in order to allow a state of increased load, in particular in the event of a crash, a deformation, and thus a change in position between the coupling sections. Loading forces, which in the event of a crash act on a user on the vehicle seat, can be reduced due to such a deformation, for example in order to counteract a whiplash injury for instance in the event of a rear crash.

To here absorb loading forces both in a front crash and in a rear crash such that in each crash direction a hold of the vehicle seat on the vehicle floor is ensured safely and reliably and no excessively large change in position of the vehicle seat can occur, an additional support here is provided via the toothed segment, which includes a support section which at loading forces acting in the event of a crash gets into a supporting interaction with a section of the flat element or with one of the associated assemblies. On a first side of the deformation section, the toothed segment is connected to the flat element. The support section can create an additional support with a section on another, second side of the deformation section and/or one of the assemblies, in order to be able to also reliably absorb and dissipate loading forces in dependence on a crash direction.

Loading forces acting in the event of a crash in the present case are meant to be those forces which in the event of a crash, in particular in a front crash or a rear crash of the vehicle, lead to a plastic deformation on the deformation section of the flat element. In the event of a crash, particularly great loading forces act on a vehicle seat, which in dependence on the crash direction load the vehicle seat for example towards the front (in the forward driving direction) or towards the rear and correspondingly to great forces also acting on a user on the vehicle seat.

At usual loading forces in a normal state of use, in particular as a result of the weight forces of a user, on the other hand there is no (plastic) deformation at the deformation section and thus neither a (significant) support via the support section of the toothed segment.

For example, the support section can be configured to support on the flat element on the second side of the deformation section in the case of a deformation of the deformation section as a result of loading forces acting on the swivel element in a front crash. The toothed segment is attached to the flat element and therefor arranged on the flat element on a first side of the deformation section. The toothed segment extends over the deformation section so that in a front crash the support section can create a support on the flat element on the second side of the deformation section facing away from the first side. In a front crash, the toothed segment thus bridges the deformation section and thereby prevents an excessive deformation on the deformation section so that loading forces acting in the front crash can reliably be absorbed and dissipated at the swivel element.

Additionally or alternatively, the support section is configured to support on an associated one of the assemblies in the case of a deformation of the deformation section as a result of loading forces acting on the swivel element in a rear crash. It can therefore be provided that in a rear crash a deformation can occur at the deformation section, as a result of which the support section gets into abutment with the associated assembly, for example in that the support section abuts against the associated assembly and thus prevents a further deformation at the deformation section.

Due to the fact that the toothed segment creates an additional support, the flat element of the swivel element can be of lightweight design. The deformation section is configured and dimensioned such that at the deformation section a deformation can occur at increased load, in particular in the event of a crash. Such a deformation for example can be stretching up of the deformation section, at which the length of the deformation section is increased. In particular, such a deformation can occur in the event of a rear crash. In the event of a front crash a lower and/or no significant deformation of the deformation section can occur as compared to a rear crash triggering similar loading forces (crash forces). An excessive deformation and thus an excessive change in position of the vehicle seat in the event of a crash is prevented by the toothed segment, which in dependence on the degree of deformation and the loading direction creates an additional support and thus prevents an excessive deformation or even breaking away at the deformation section.

In one embodiment, the support section includes a capturing opening. The flat element on the other hand includes a capturing element, for example in the form of a trunnion. The capturing opening for example is of semicircular design, for instance as an indentation formed at the toothed segment and thus unilaterally open. The capturing opening and the capturing element are configured and arranged relative to each other such that the capturing opening and the capturing element can engage into each other to support the support section on the flat element on the second side of the deformation section. While the toothed segment is attached to the flat element on the first side of the deformation section, the capturing element is arranged on the flat element on the second side of the deformation section. For example in a front crash the capturing element is in engagement with the capturing opening of the support section so that a support between the toothed segment and the flat element thereby is created on the second side of the deformation section and the toothed segment thus bridges the deformation section.

According to one development it can be provided that the deformation section is arranged and/or configured such that in the event of a front crash it is deformed less than in the event of a rear crash. In particular, it can be provided that the deformation section is arranged and/or configured such that it is stretched in the event of a rear crash. Thus, it is also possible that the capturing element is moved out of the capturing opening, whereby a load path between the capturing element and the capturing opening is eliminated. In the front crash, the swivel element hence remains as stiff as possible, whereas it is deformed in the rear crash in order to form a different load path for dissipating loading forces.

The capturing element for example can be configured in the form of a trunnion.

In one embodiment, the support section is configured to abut against a flat section of the assembly for supporting the support section on the associated assembly. In a normal position of use, the support section preferably is not in abutment with the assembly. At an increased load, in particular in the event of a crash, for example in a rear crash, the support section on the other hand is approached to the assembly and gets into abutment with the assembly due to a deformation at the deformation section, so that a flux of force is created between the toothed segment and the assembly and crash forces thus can be introduced into the assembly via the toothed segment. There is obtained a secondary flux of force for example from the adjustment drive at one of the assemblies via the toothed segment into the other one of the assemblies and thus a flux of force which is independent of the flat element and the deformation section molded thereto.

In one embodiment, the support section in a normal state of use is not supported on the flat element on the second side of the deformation section and/or not supported on the associated assembly. Thus, the support section is spaced apart for example from an associated capturing element on the second side of the deformation section and moreover neither is in a supporting abutment with an associated one of the assemblies. There is obtained an arrangement in which an overdetermination is avoided in the normal state of use and in which the swivel element in a normal use for adjusting the assemblies can be pivoted in a smooth and low-noise way.

It is also conceivable, however, that in the normal state of use the support section for example already is in abutment with a capturing element at the flat element on the second side of the deformation section and thus, in the normal state of use, the engagement between the capturing element and an associated capturing opening exists already at the support section.

In one embodiment, the swivel element can be pivoted about a first pivot axis relative to the first assembly and about a second pivot axis, which extends parallel to the first pivot axis, relative to the second assembly. Thus, the swivel element is pivotable relative to the two associated assemblies and, driven by the adjustment drive, can be moved relative to the assemblies so as to adjust the assemblies relative to each other.

In one embodiment, the flat element includes a first flat section arranged on the first side of the deformation section and a second flat section arranged on the second side of the deformation section. The first flat section for example can form the first coupling section for coupling with the first assembly, while the second flat section for example forms the second coupling section for coupling with the second assembly. The deformation section here is structurally different from the first flat section and the second flat section, for example in that the deformation section is bent around a first bending edge towards the first flat section and around a second bending edge towards the second flat section. In the region of the deformation section, the flat element in particular has a reduced rigidity—with respect to loading forces acting in the event of a crash (in particular in a front crash or rear crash)—, so that in the case of loading forces acting in the event of a crash a deformation chiefly occurs in the region of the deformation section. In dependence on the direction of the loading forces, for example a compression or elongation can occur at the deformation section so that the location of the coupling sections of the flat element can change in dependence on the deformation at the deformation section in the event of a crash.

Preferably, the first bending edge and the second bending edge are not directed parallel to each other. Alternatively, the first bending edge and the second bending edge can be directed parallel to each other. The first bending edge and the second bending edge are arranged in a common plane, but are extended obliquely to each other. Alternatively, the first bending edge and the second bending edge can be arranged in different planes. By aligning the bending edges, the deformation behavior at the deformation section can be influenced so that in the event of a crash a defined deformation behavior occurs at the deformation section in dependence on the direction of the loading forces.

In one embodiment, the first flat section and the second flat section are extended along a plane perpendicular to the first pivot axis and to the second pivot axis. The first flat section and the second flat section advantageously are arranged in a common plane and thus are aligned with each other within the common plane. The deformation section is bent over towards the flat sections at the bending edges and for example, as seen along a direction perpendicular to the plane, flared from the flat sections so that the deformation section protrudes from the first flat section and from the second flat section.

The pivot axes in particular are directed along the vehicle transverse direction so that in a front crash and in a rear crash the loading forces at least approximately act in the plane within which the flat sections of the flat element are extended. The toothed segment is attached to the first flat section. The support section is configured to support on the second flat section or on one of the assemblies in the case of a deformation of the deformation section as a result of loading forces acting on the swivel element in the plane in the event of a crash. On the second flat section for example a capturing element can be arranged, which in dependence on the direction of the acting loading forces provides a support by engagement into a capturing opening at the support section.

The adjustment drive, in one embodiment, is arranged on one of the assemblies. The adjustment drive thus is stationarily connected to one of the assemblies and is operatively connected to the toothed segment at the swivel element via the pinion element. Driven by the adjustment drive, the pinion element meshes with the toothed segment and in this way pivots the swivel element relative to the assembly on which the adjustment drive is arranged. There is obtained a flux of force from the adjustment drive into the toothed segment and via the same into the swivel element, wherein in the event of a crash, for example in a rear crash, the toothed segment for example supportingly gets into abutment with the other one of the assemblies (i.e. the assembly on which the adjustment drive is not arranged), so that a secondary flux of force is produced between the adjustment drive on the one assembly, the toothed segment and the other assembly.

The first assembly for example can be a frame part of a seat frame of the vehicle seat. The second assembly on the other hand can be realized for example by a guide rail of a longitudinal adjustment device of the vehicle seat. The swivel element for example can be pivotable relative to the two assemblies so that by pivoting the swivel element for example the height position of the seat frame relative to the longitudinal adjustment device can be changed and the adjustment device thus realizes a height adjustment device.

The adjustment device can, however, also realize another adjustment device for adjusting other seat assemblies relative to each other. In general, a swivel element of the described type can be used in every adjustment device in which a swivel element driven by an adjustment drive is moved relative to an associated assembly.

In one embodiment, a vehicle seat comprises an adjustment device of the described type. The vehicle seat can include a seat part and a backrest part tilt-adjustably connected to the seat part. The seat part is coupled with a floor assembly, for example a longitudinal adjustment device, for example via an adjustment device of the described type for realizing a height adjustment device.

### BRIEF DESCRIPTION OF THE DRAWINGS

The idea underlying the solution will be explained in detail below with reference to the exemplary embodiment illustrated in the Figures.

FIG. 1 shows a view of an exemplary embodiment of a vehicle seat.

FIG. 2 shows a separate view of a swivel element of an adjustment device.

FIG. 3 shows another view of the swivel element.

FIG. 4 shows a perspective view of the swivel element.

FIG. 5 shows another perspective view of the swivel element.

FIG. 6 shows a view of the swivel element between associated assemblies, in a front crash.

FIG. 7 shows a view of the swivel element, after a deformation in a rear crash.

### DETAILED DESCRIPTION

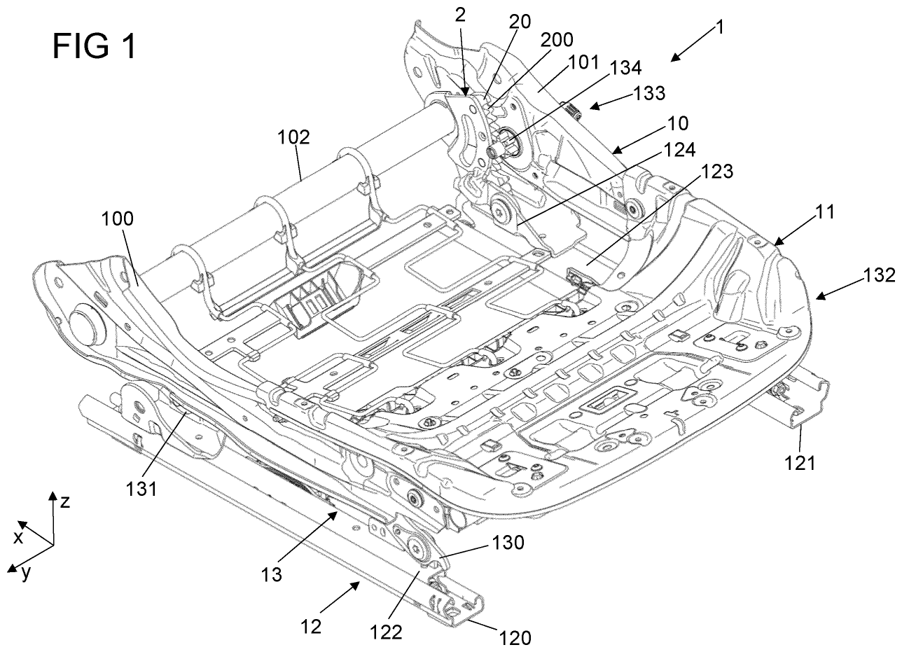

FIG. 1 shows an exemplary embodiment of a vehicle seat 1, which realizes a seat framework for forming a seat frame 10 to provide a seat part. The seat frame 10 includes lateral frame parts 100, 101 which are connected to each other via a transverse tube 102 and carry a seat pan 11 on which a seating surface is formed for a vehicle occupant.

In the illustrated exemplary embodiment, the seat frame 10 is coupled with a floor assembly in the form of a longitudinal adjustment device 12 via a height adjustment device 13.

The longitudinal adjustment device 12 includes two pairs of guide rails 120, 121, 122, 123 of which lower guide rails 120, 121 are connected to a vehicle floor. Upper guide rails 122, 123 are longitudinally shiftable relative to the lower guide rails 120, 121 along a longitudinal direction X so that the longitudinal position of the vehicle seat 1 in a vehicle can be adapted.

The height adjustment device 13 includes swivel elements 130, 131, 132, 2 which at one end each are pivotally connected to an associated one of the upper guide rails 122, 123 and with another, second end are pivotally connected to an associated one of the frame parts 100, 101 of the seat frame 10 so that the swivel elements 130, 131, 132, 2 form two pairs of four-bar linkages which provide for a height adjustment of the seat frame 10 relative to the longitudinal adjustment device 12.

In the height adjustment device 13 the swivel element 2 as an active element is driven by an adjustment drive 133, while the other swivel elements 130, 131, 132 are passively moved along on pivoting of the swivel element 2. The adjustment drive 133 is arranged on an associated frame part 101 of the seat frame 10 and includes a pinion element 134 with meshes with a toothing 200 of a toothed segment 20 of the swivel element 2. During a rotation of the pinion element 134, driven via the adjustment drive 133, the swivel element 2 thus is pivoted relative to the frame part 101 and also to the associated guide rail 123, so that the location of the swivel element 2 and hence also the location of the other swivel elements 130, 131, 132 between the seat frame 10 and the longitudinal adjustment device 12 also is changed and the height adjustment of the seat frame 10 hence can be adapted.

The swivel element 2 is firmly connected to the transverse tube 102 at one end. The transverse tube 102 is pivotable relative to the frame parts 100, 101 so that the swivel element 2 can be pivoted relative to the seat frame 10. At its other end, the swivel element 2 is pivotally coupled with an attachment part 124 in the form of an angular element at the guide rail 123.

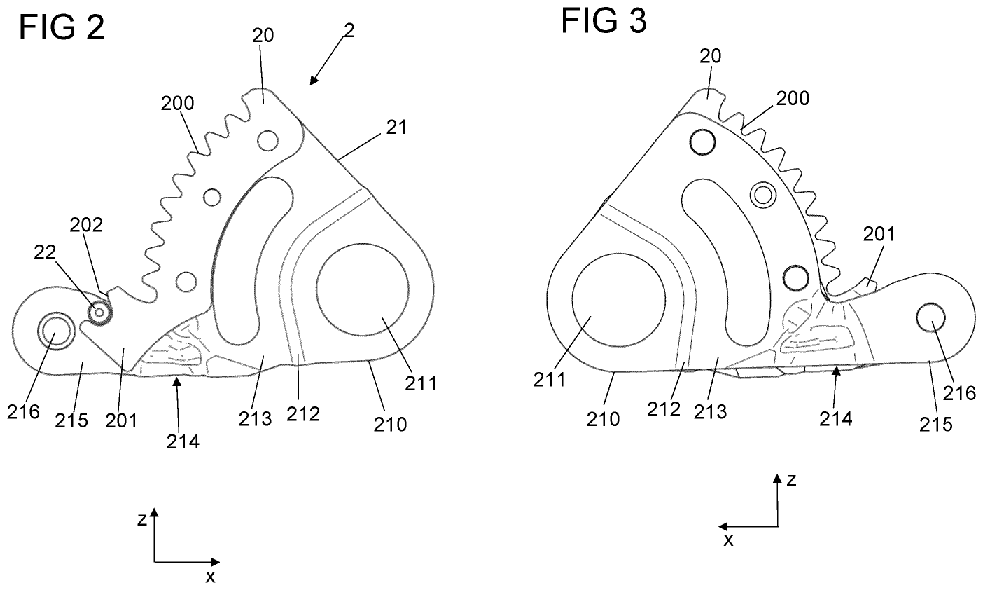

As this can be taken from the separate views of the swivel element 2 as shown in FIGS. 2 to 5, the swivel element 2 includes a toothed segment 20 which is attached to a flat element 21. The toothed segment 20 and the flat element 21 are designed as separate elements. The toothed segment 20 for example is fixed to a flat section 213 of the flat element 21 via rivets or other fastening elements.

The toothed segment 20 forms a toothing 200 with which the pinion element 134 of the adjustment drive 133 meshes, as this can be taken from FIG. 1. In an extension of the toothing 200 the toothed segment 20 also forms a support section 201 to which a capturing opening 202 is molded.

The flat element 21, which for example can be formed by a bent sheet-metal part, for example as a stamped and bent part, includes a first coupling section 210 with an opening 211 formed therein, via which the flat element 21 is attached to the transverse tube 102 of the vehicle 1 (see FIG. 1). Via a step 212 the coupling section 210 transitions into the flat section 213 to which the toothed segment 20 is attached.

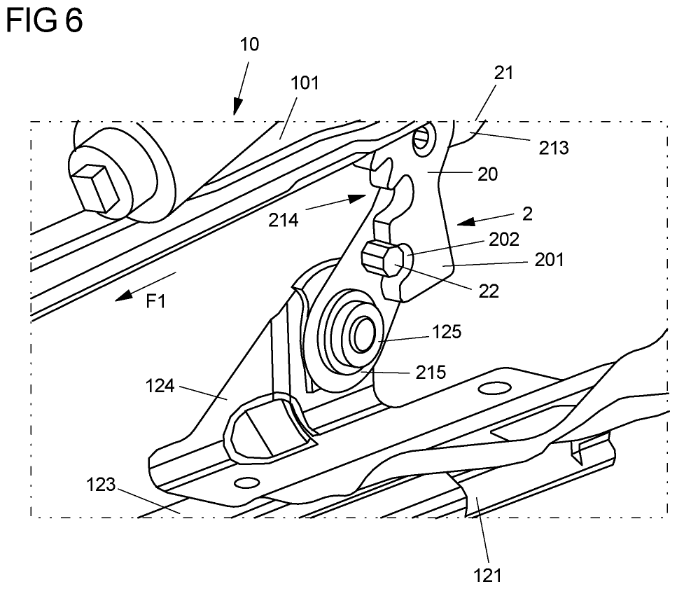

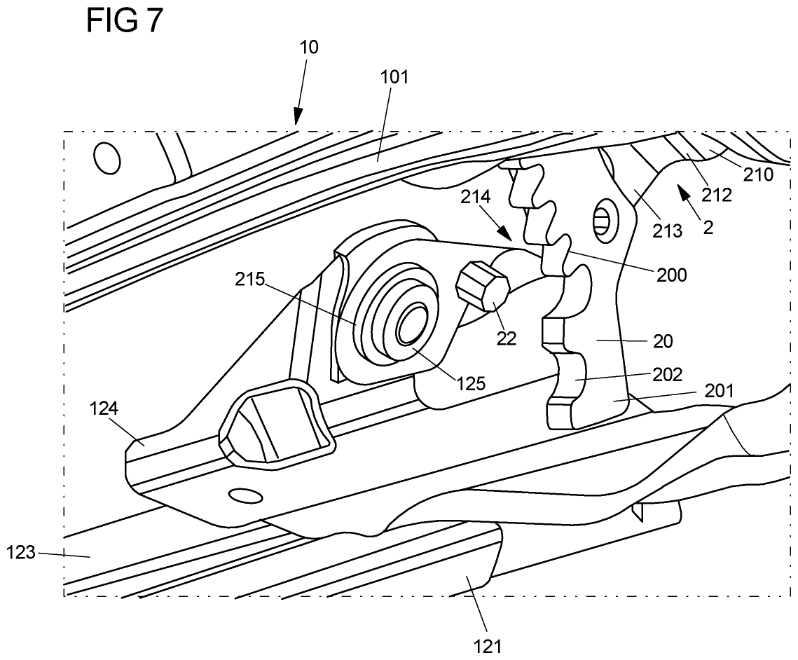

The flat element 21 also includes a second coupling section 215 with a bearing opening 216 formed therein, which preferably is configured as a rim hole through which a bearing element 125, which preferably is configured as a stepped pin, reaches in the mounted position, via which the swivel element 2 is pivotally coupled with the attachment part 124 of the guide rail 123, as this can be taken for example from FIGS. 6 and 7. The coupling section 215 is realized by a flat section of the flat element 21, which jointly with the flat section 213 is extended along a plane perpendicular to pivot axes S1, S2, as this can be taken from FIG. 5. The swivel element 2 is pivotable about the pivot axes S1, S2 on the one hand relative to the seat frame 10) (pivot axis S1) and on the other hand relative to the associated guide rail (pivot axis S2).

The flat sections 213, 215 of the flat element 21 are connected to each other via a deformation section 214, which is bent around bending edges B1, B2 towards the respectively adjacent flat section 213, 215 and is flared perpendicularly to the plane of the flat sections 213, 315, so that the deformation section 214 extends out of the plane and protrudes relative to the flat sections 213, 215.

The deformation section 214 provides for a deformation at the swivel element 2 with large loading forces, in particular in the event of a crash, for example in a front crash or in a rear crash. Due to a deformation at the deformation section 214 the coupling sections 210, 215 and thus the pivot axes S1, S2 can change their position relative to each other, when a deformation occurs at the swivel element 2 due to large loading forces. By providing such a crumple zone, the forces acting on a user in the event of a crash, in particular the high-energy load cases, can be attenuated.

To here provide for a light-weight configuration of the swivel element 2, in particular of the flat element 21, forces are dissipated in the event of a crash not alone via the flat element 21 and thus along a flux of force via the deformation section 214. Instead, an additional support is created via the toothed segment 20, which independently of the direction produces a flux of force bridging the deformation section 214 and thus provides for a dissipation of crash forces from the seat frame 10 into the floor assembly, while at the same time an excessively large change in position of the vehicle seat 1 or even tearing off in the event of a crash is avoided.

The support via the toothed segment 20 is effected in different ways in dependence on the direction of the crash.

For support in a front crash at crash forces F1, which in particular are directed forwards, as this can be taken from FIG. 6, a capturing element 22 in the form of a trunnion is arranged on the flat section of the flat element 21 forming the coupling section 215, which is configured to create a support by bridging the deformation section 214 via an engagement into the capturing opening 202 at the support section 201. Via the support section 202, the toothed segment 20 bridges the deformation section 214 by engagement of the engagement element 22, as shown in FIG. 6, in a front crash and with the acting loading forces F1, so that a secondary frictional connection with the coupling section 215 and thereby the attachment part 124 of the floor assembly is created via the toothed segment 20.

Due to the cylindrical configuration of the capturing element 22, the capturing element 22 here provides a pivot point which on deformation of the deformation section 214 provides for a rotatory deformation at the swivel element 2, which due to the shape of the deformation element 214, for example as a result of the alignment of the bending edges B1. B2, however is limited to a comparatively small angle.

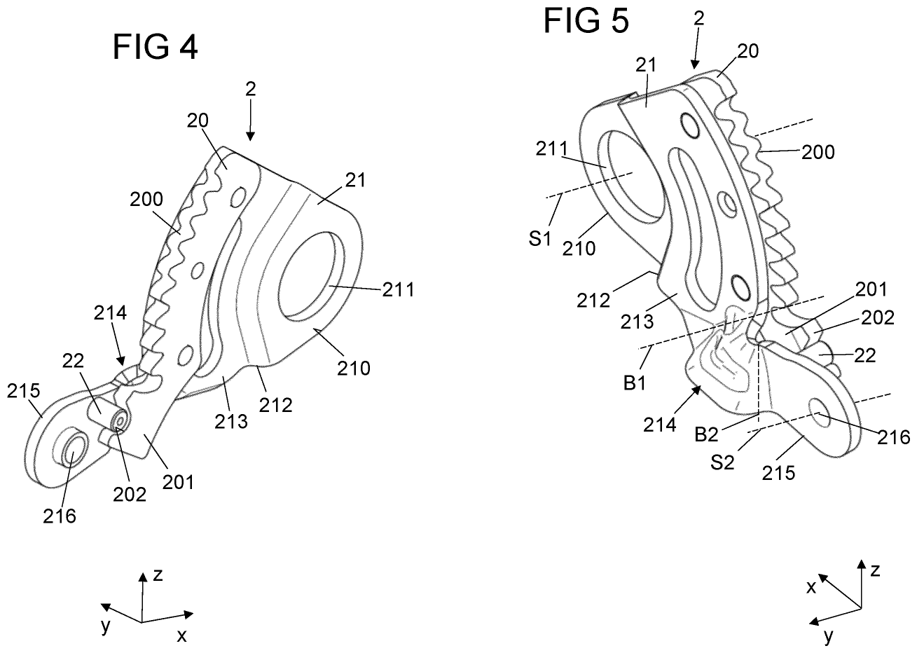

In a normal position of use, as can be taken from FIGS. 2 and 4, the capturing element 22 can already be in engagement with the capturing opening 202 at the support section 201. It is also conceivable, however, that the capturing element 22 gets into engagement with the capturing opening 202 at the support section 201 only with a deformation at the deformation section 214 due to large loading forces in a front crash.

For support in a rear crash with crash forces F2, which in particular are directed to the rear, as this can be taken from FIG. 7, the deformation section 214 in particular can be deformed in the sense of an elongation. The support section 201 of the toothed segment 20 is configured such that in the case of a deformation of the deformation section 214 in a rear crash the support section 201 abuts against an upper flat section of the guide rail 123 and thus due to the abutment creates a secondary frictional connection of the floor assembly from the seat frame 10) via the toothed segment 20 directly with the guide rail 123. In a rear crash, an additional support beside the actual flux of force thus is created via the flat element 21 of the swivel element 2, so that crash forces can be absorbed reliably and in particular a deformation beyond the deformation at the flat element 21 as shown in FIG. 7 is prevented.

Because the toothed segment 20 is used for additional support by creating a secondary flux of force, the flat element 20 can be designed of comparatively light weight and correspondingly at low cost.

The idea underlying the solution is not limited to the exemplary embodiments described above but can also be realized in a different way.

An adjustment device of the described type can realize a height adjustment device of a vehicle seat, like in the illustrated exemplary embodiment. It is also conceivable, however, to use a swivel element of the described type in another adjustment device for adjusting assemblies of a vehicle seat relative to each other.

### LIST OF REFERENCE NUMERALS

1 vehicle seat
10 seat frame
100, 101 frame part
102 transverse tube
11 seat pan
12 longitudinal adjustment device
120, 121 lower guide rail
122, 123 upper guide rail
124 attachment part
125 bearing element
13 height adjustment device
130-132 swivel element (swing arm)
133 drive
134 pinion element
2 swivel element
20 toothed segment
200 toothing
201 support section
202 capturing opening
21 flat element
210 coupling section
211 opening
212 step
213 flat section
214 deformation section
215 coupling section
216 bearing opening
22 engaging element
B1, B2 bending edge
F1, F2 loading force
S1, S2 pivot axis
X longitudinal direction
Y transverse direction
Z vertical direction

1. An adjustment device for a vehicle seat, comprising
a first assembly,
a second assembly adjustable relative to the first assembly,
a swivel element which includes a toothed segment and a flat element connected to the toothed segment and is pivotable for adjusting the first assembly and the second assembly relative to each other, and
an adjustment drive which includes a pinion element cooperating with the toothed segment, which can be driven to pivot the swivel element,
wherein the flat element includes a first coupling section coupled with the first assembly, a second coupling section coupled with the second assembly, and a deformation section arranged between the first coupling section and the second coupling section,
wherein the toothed segment includes a support section, wherein the toothed segment is connected to the flat element on a first side of the deformation section, and in the case of a deformation of the deformation section as a result of loading forces acting on the swivel element in the event of a crash the support section is configured to support at least one of on the flat element on a second side of the deformation section and on one of the first assembly and the second assembly.

2. The adjustment device according to claim 1, wherein the support section is configured to support on the flat element on the second side of the deformation section in the case of a deformation of the deformation section as a result of loading forces acting on the swivel element in a front crash.

3. The adjustment device according to claim 1, wherein the support section is configured to support on the one of the first assembly and the second assembly in the case of a deformation of the deformation section as a result of loading forces acting on the swivel element in a rear crash.

4. The adjustment device according to claim 1, wherein the support section includes a capturing opening and the flat element includes a capturing element, wherein the capturing opening and the capturing element are configured to engage into each other for supporting the support section on the flat element on the second side of the deformation section.

5. The adjustment device according to claim 1, wherein the support section is configured to abut against a flat section of the one of the first assembly and the second assembly for supporting the support section on the one of the first assembly and the second assembly.

6. The adjustment device according to claim 1, wherein in a normal state of use of the swivel element the support section is at least one of not supported on the flat element on the second side of the deformation section and not supported on the one of the first assembly and the second assembly.

7. The adjustment device according to claim 1, wherein the swivel element is pivotable about a first pivot axis relative to the first assembly and about a second pivot axis, which extends parallel to the first pivot axis, relative to the second assembly.

8. The adjustment device according to claim 7, wherein the flat element includes a first flat section arranged on the first side of the deformation section and a second flat section arranged on the second side of the deformation section, wherein the deformation section is bent about a first bending edge towards the first flat section and about a second bending edge towards the second flat section.

9. The adjustment device according to claim 8, wherein the first bending edge and the second bending edge are directed parallel or not parallel to each other.

10. The adjustment device according to claim 8, wherein the first flat section and the second flat section are extended along a plane perpendicular to the first pivot axis and to the second pivot axis.

11. The adjustment device according to claim 10, wherein the toothed segment is attached to the first flat section and the support section is configured to support on the second flat section in the case of a deformation of the deformation section as a result of loading forces acting on the swivel element in the plane in the event of a crash.

12. The adjustment device according to claim 10, wherein the deformation section, as seen along a direction perpendicular to the plane, protrudes relative to the first flat section and to the second flat section.

13. The adjustment device according to claim 1, wherein the adjustment drive is arranged on at least one of the first assembly and the second assembly.

14. The adjustment device according to claim 1, wherein at least one of the first assembly is a frame part of a seat frame of the vehicle seat and the second assembly is a guide rail of a longitudinal adjustment device of the vehicle seat.

15. (canceled)

16. The adjustment device according to claim 1, wherein the adjustment device is a height adjustment device for the height adjustment of the vehicle seat.

17. The adjustment device according to claim 1, wherein the swivel element is at least one of arranged and configured such that in the case of a front crash the capturing element engages into the capturing opening so that a power transmission between capturing element and capturing opening is possible, and that in the case of a rear crash the capturing element lies outside the capturing opening so that no power transmission is possible between capturing element and capturing opening.

18. The adjustment device according to claim 1, wherein the deformation section is at least one of arranged and configured such that in a front crash it is deformed less than in a rear crash.

19. The adjustment device according to claim 1, wherein the swivel element is at least one of arranged and configured such that in the case of a rear crash the capturing element is moved out of the capturing opening due to a deformation of at least one of the deformation section and the support section slips away downwards until it abuts against the flat section and a force dissipation thereby is possible.

20. The adjustment device according to claim 19, wherein the deformation is a stretching of the deformation section.

21. A vehicle seat comprising an adjustment device according to claim 1.
